(19) United States
(12) Patent Application Publication
(10) Pub. No.: US 2010/0186163 A1
(43) Pub. Date: Jul. 29, 2010

(54) RAISING WHEELCHAIR CONVERTIBLE TO A STRETCHER

(76) Inventor: Miguel Angel Torrá Sorribes, Lleida (ES)

Correspondence Address: Mark Levy;HINMAN, HOWARD & KATTELL, LLP, 80 Exchange Street, P.O. Box 5250, BINGHAMTON, NY, 13901, US

(21) Appl. No.: 12/669,562

(22) PCT Filed: Jul. 18, 2007
(86) PCT No.: PCT/ES07/00621

§ 371 Date: Jan. 19, 2010

(30) Foreign Application Priority Data
Jul. 18, 2007 (ES) P200702001

(51) Int. Cl. A61G 7/16; A61G 1/017; A61G 5/00; A61G 5/10

(52) U.S. Cl. 5/86.1

(57) ABSTRACT

Raising wheelchair convertible to a stretcher, incorporating a seat, a backrest, foot-rests, arm-rests, a set of fixed back wheels, and another set of front directionally rotating wheels, and comprising a rolling base incorporating back wheels and front wheels; a raising upper frame, which in turn includes, at least, the seat, the backrest, and the foot-rests; as well as raising means for the upper frame; while the arm-rests are hinged to the upper frame so as to allow lateral folding thereof in order to create a stretcher in continuation with the seat.

This invention relates to a raising wheelchair convertible to a stretcher, mainly adapted to easily transfer its occupant to a bed.

### BACKGROUND OF THE INVENTION

Wheelchairs provided with a seat, backrest, arm-rests, and a set of fixed back wheels, and another set of front directionally rotating wheels are currently known, said chairs being intended to be driven from its back handles, either by the users themselves or by using a motor.

These wheelchairs are provided with large size back wheels, precisely to allow the independent propulsion by the user, and with a permanent chair structure.

A disadvantage of these state-of-the-art wheelchairs is that in their design do not contemplate configurations aiming at effectively helping in the transfer of a user from the chair to a bed, and vice versa, this being a very strenuous and often an impossible task to achieve when not conducted in a health facility and/or with the help of specially trained people.

### DESCRIPTION OF THE INVENTION

The raising wheelchair convertible to a stretcher of this invention has a design such that a common person, i.e. one lacking special training to that end, is able to transfer a disabled user from bed to the wheelchair, and vice versa.

The chair of the invention comprises a seat, a backrest, foot-rests, arm-rests, and a set of fixed back wheels, and another set of front directionally rotating wheels, as well as driving handles. Motor-driven means may also be incorporated.

The novelty proposed by the invention is to provide the chair with a rolling base incorporating both the back and the front wheels; and a raising upper frame which in turn includes at least the seat, the backrest, and the foot-rests.

The invention also contemplates the implementation of raising means for the upper frame (12), as well as the hinged assembly of the arm-rests to the upper frame (12), which allows lateral folding thereof so as to create a stretcher in continuation with the seat. In order for this to occur, the arm-rests are conveniently prepared by incorporating supporting surfaces therein.

In addition, the possibility to raise the upper frame allows to place configured stretcher on a bed, and to easily transfer the use from the stretcher to a bed, and vice versa, without having to lift the user or load him/her on weight.

### BRIEF DESCRIPTION OF THE DRAWINGS

As a complement to the description being made, and in order to better understand the characteristics of the invention, in accordance to a preferred embodiment thereof, a set of drawings accompanies such description, said drawings being illustrative rather than limitative in nature, and representing as follows:

FIG. 1 shows a side view of the wheelchair of the invention.

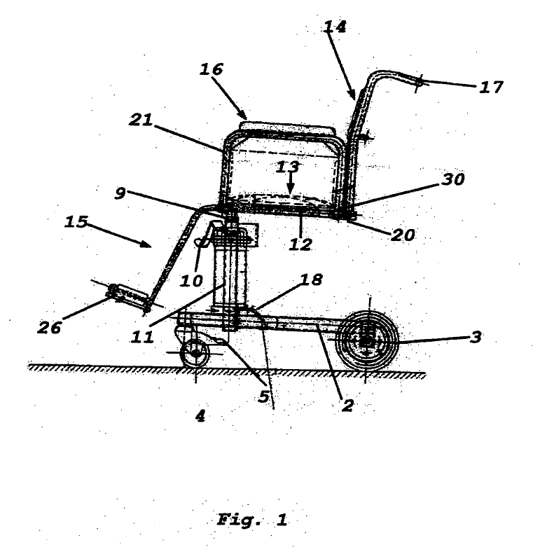

FIG. 2 shows a side view of the chair of the invention during conversion thereof to a stretcher and placement for user's transfer to bed o vice versa.

FIG. 3 shows a top view of the wheelchair of the invention configured as a stretcher, and placed on the bed for user transfer purposes.

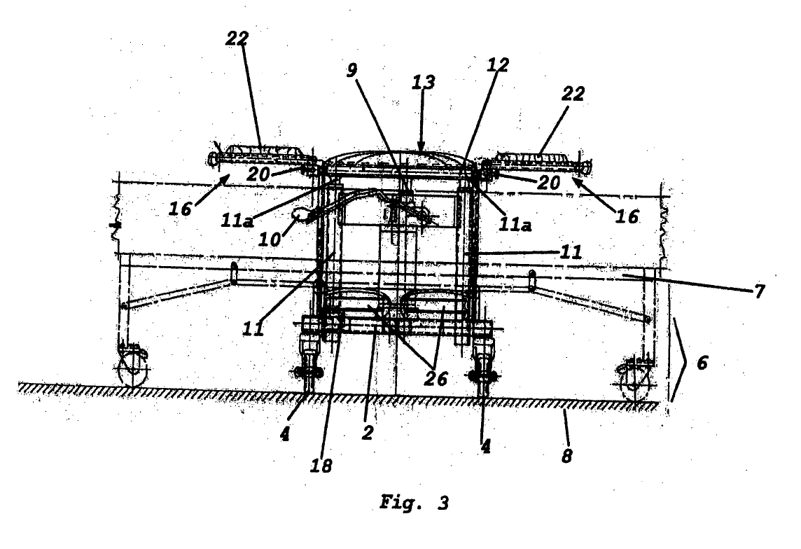

### DESCRIPTION OF AN EMBODIMENT OF THE INVENTION

The wheelchair (1) of the invention comprises a rolling base (2), wherein a set of fixed back wheels (3), and preferably provided with an air chamber, and another set of front directionally rotating wheels (4), and provided with a brake (5) are mounted, the back wheels (3) being reduced in diameter so as to fit in the space (6) between a bed (7), and the floor (8).

On the rolling base (2) raising means for the upper frame (12) are mounted, said raising means preferably comprising a centered and considerably vertical hydraulic piston (9), with a reservoir, and an hydraulic station, and lever control (10), these being integrated thereto, and also comprising ideally telescopic side tracks (11).

The upper raising frame (12) includes at least the seat (13), the backrest (14), foot-rests (15), and arm-rests (16), wherein at its lower part the telescopic lengths (11a) of the telescopic tracks (11) are connected so as to conduct raising of the upper frame (12), and avoid bulging of the hydraulic piston (9) that might be likely to alter the chair balance, and specially when it has been converted to a stretcher.

Further, handles (17) are integrated to the backrest (14) which allows pushing and comfortably guiding the wheelchair (1) of the invention.

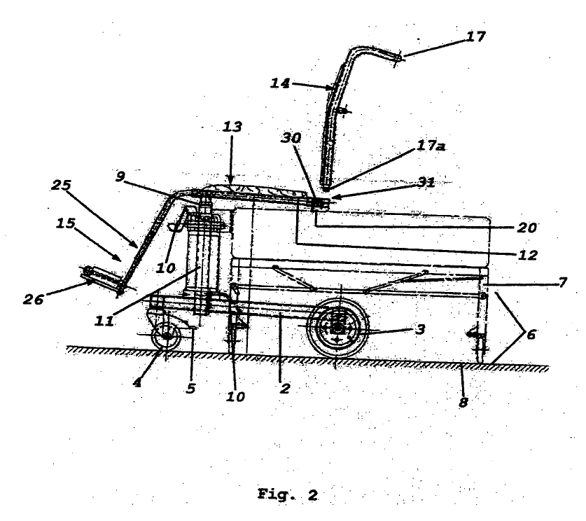

The position of the raising means—the piston (9) in this instance of the invention—is considerably moved forward so that the seat (13), when in the raised position, is made to hover on the bed (7) by placing the back wheels (3) under the bed, as shown in FIG. 2. A stop (18) is provided which during this action protects the piston (9) or other raising means from impacts against the bed structure (7).

In this example of the invention, the stop (18) is a folding stop so as to limit the lever stroke (10) during the elevation of the upper frame (12), and to increase it during lowering thereof. Therefore, the piston will be of the pumping type if a certain stroke is not exceeded, and of the emptying type, if such stroke is exceeded. In addition, the piston will be comprised of telescopic sleeve and piston, a hydraulic station, an oil tank, and anti-return and tank discharge valves.

Arm-rests (16) are also articulated to the upper raising frame (12) by means of a hinge member so as to allow for side folding thereof in order to create a stretcher in continuation with the seat (13).

Each of the arm-rests (16) comprises a structure, whereby they are hinged to the upper frame (12). A supporting surface (22) is mounted to said structure, which, along with the seat and counterpart surface of the other arm-rest (16), conform the stretcher surface. Said structures included in the arm-rests (16) are each comprised of bridges (21). These supporting surfaces (22) as well as the seat (13) are suitably upholstered in knitted and preferably transpirable material, such as fabric, leather, or any other officially recognized material this kind of patients.

The upper frame (12) includes arm-rest unlocking means (16) as well as other backrest unlocking and release means (14). The inclusion of these unlocking mechanisms allows removal of the backrest (14) and folding of the arm-rests (16) so as to create the stretcher, as shown in FIG. 2, and even, the arm-rests may be left in place if the patient is not to be transferred to the bed by the backrest area.

The backrest unlocking and release means (14), and the arm-rest unlocking means (16) are comprised of small retrievable latches (20) which simultaneously engage a first group of holes in the projections (17a) of the backrest (14), and a second group of holes in the bridges (21) included in the structures of both arm-rests (16).

Said small latches (20) each run along side guides (30) joined to the upper frame (12), adjacent to the bridges (21) where the second group of locking holes are implemented for locking purposes, and each being provided in turn with housings (31) to receive and support projections (17a) of the backrest (14), where the first group of locking holes of the small latches (20) are implemented.

The seat (13) is mounted to the upper frame (12) and able to laterally rotate so as to allow alignment of user with perpendicular configurations of the stretcher and the wheelchair. This assembly is preferably conducted by means of a ball bearing, not shown.

Further, the foot-rests (15) are adjustable and telescopic by means of retainers (25) which allow setting extension thereof. Also, the foot-rests (15) contain laterally folding foot platforms (26) in order to make user standing motion or placement easier.

In order to place user on the bed (7), first the upper frame (12) is raised until it is over on the bed (7), while the back wheels (3) are placed under the bed, whereby the seat (3) is made to hover on the bed (7). The small latches (20) are unlocked so as to fold the arm-rests (16), thus forming the stretcher. User's legs are lifted, and the seat is rotated 90 degrees relative to the upper frame, so that it is longitudinally in line with the stretcher. Thus this stretcher height is adjusted so that it is as close to the bed as possible (7); then the backrest (14) is removed, by acting again on the small latches (20), in order to easily transfer the user to the bed, and vice versa.

Then, the stretcher is removed, and the backrest (14) and arm-rests (16) are replaced, whereby regains the configuration of a chair, and height is adjusted again.

1-19. (canceled)

20. A raisable wheelchair convertible to a stretcher, comprising:
a) a frame;
b) a seat supported by said frame;
c) a backrest operatively connected to said frame;
d) two foot rests operatively connected to said frame; and
e) raising means operatively connected to said frame.

21. The raisable wheelchair convertible to a stretcher in accordance with claim 1, further comprising a pair of arm rests, each of said arm rests disposed on an opposite side of said seat.

22. The raisable wheelchair convertible to a stretcher in accordance with claim 21, wherein said raising means comprises a hydraulic piston.

23. The raisable wheelchair convertible to a stretcher in accordance with claim 22, further comprising a pair of side guides each of said side guides disposed on an opposite side of said hydraulic piston.

24. The raisable wheelchair convertible to a stretcher in accordance with claim 23, wherein said pair of side guides is telescopic.

25. The raisable wheelchair convertible to a stretcher in accordance with claim 20, wherein said arm rests are hinged to said frame.

26. The raisable wheelchair convertible to a stretcher in accordance with claim 21, wherein said hydraulic piston comprises a hydraulic reservoir.

27. The raisable wheelchair convertible to a stretcher in accordance with claim 26, further comprising a lever control for said hydraulic piston operatively connected thereto.

28. The raisable wheelchair convertible to a stretcher in accordance with claim 20, further comprising two sets of wheels for moving said raisable wheelchair.

29. The raisable wheelchair convertible to a stretcher in accordance with claim 20, further comprising a brake for slowing and stopping movement of said raisable wheelchair.

30. The raisable wheelchair convertible to a stretcher in accordance with claim 20, further comprising a handle connected to said back rest for controlling direction and speed of said raisable wheelchair.

31. The raisable wheelchair convertible to a stretcher in accordance with claim 20, further comprising a pair of folding foot platforms, each of said platforms being hingedly connected to a respective foot rest.

32. The raisable wheelchair convertible to a stretcher in accordance with claim 28, wherein two of said wheels are directionally rotating.

33. The raisable wheelchair convertible to a stretcher in accordance with claim 21, wherein said pair of arm rests is removable.
